(19) United States
(12) Patent Application Publication
(10) Pub. No.: US 2017/0338568 A1
(43) Pub. Date: Nov. 23, 2017

(54) CIRCUMFERENCIAL FRAME FOR ANTENNA BACK-LOBE AND SIDE-LOBE ATTENTUATION

(71) Applicant: COMMSCOPE TECHNOLOGIES LLC, Hickory, NC (US)

(72) Inventors: Claudio Biancotto, Edinburgh (GB); Elham EBRAHIMI, Edinburgh (GB); Christopher D. HILLS, Glenrothes (GB)

(21) Appl. No.: 15/523,843

(22) PCT Filed: Nov. 3, 2015
(86) PCT No.: PCT/US2015/058773

§ 371 Date: May 2, 2017

Related U.S. Application Data
(60) Provisional application No. 62/074,277, filed on Nov. 3, 2014.

(51) Int. Cl. H01Q 17/00; H01Q 21/00; H01Q 1/42; H01Q 21/06; H01Q 15/16

(52) U.S. Cl. CPC H01Q 17/001; H01Q 21/00; H01Q 1/42; H01Q 15/16; H01Q 21/061

(57) ABSTRACT

In one embodiment, an antenna system includes a device for attenuating undesirable radiation from an antenna. The device includes a perimeter plate adapted to be located around the perimeter of the antenna. The perimeter plate has one or more concentric perimeter bands, where each perimeter band comprises an array of distinct EM-field-suppressing features. The surface of each suppressing features is metallic. The dimensions, arrangement, and number of the suppressing features are such that the features form a meta-material and the perimeter plate attenuates back-lobe and/or side-lobe radiation generated by the antenna.

This application claims the benefit of the filing date of U.S. Provisional Application No. 62/074,277, filed on Nov. 3, 2014, the teachings of which are incorporated herein by reference in their entirety.

### BACKGROUND

### Field

The current disclosure relates to controlling antenna radiation and particularly, although not exclusively, to attenuating antenna back-lobe and side-lobe radiation.

### Description of the Related Art

Antennas are used to transmit and receive electromagnetic (EM) radiation signals, such as microwave communication. The strength of a transmitting antenna's signal in various directions can be represented by a radiation pattern. The antenna radiation pattern may be divided into (i) a forward hemisphere corresponding generally to the intended direction of transmission and (ii) a complementary, backward hemisphere. The main signal in the forward direction is referred to as the main lobe, while signals in the backward direction are referred to as back lobes, and signals in other directions are referred to as side lobes. Note that side lobes may be in the forward hemisphere and/or backward hemisphere.

In many antenna applications, it is desirable to have the signal power concentrated in the intended direction of transmission within the forward hemisphere while limiting signal power in the backward hemisphere. Attenuation of back-lobe and side-lobe radiation may also be necessary for compliance with regulatory requirements in order to, for example, reduce interference with other nearby antennas. Conventional means for reducing back-lobe and side-lobe radiation for an antenna include adding microwave-absorbing materials and/or metal shielding, which may result in undesirable changes to the profile and structure of the antenna. For example, the addition of radiation-absorbing and/or radiation-shielding materials may significantly change the physical profile of the antenna and, consequently, adversely affect the antenna's mechanical, aerodynamic, and/or aesthetic qualities.

In some conventional applications, choke plates with continuous parallel grooves are used to attenuate some unwanted radiation. However, the continuous parallel grooves of the conventional choke plates may have limited effectiveness depending on the direction of the grooves and the polarization of the signal.

### SUMMARY

One embodiment of the disclosure can be an article of manufacture comprising a perimeter plate adapted to be located around the perimeter of the antenna. The perimeter plate comprises one or more concentric perimeter bands. Each perimeter band comprises a plurality of distinct EM-field-suppressing features. The surface of each suppressing feature is metallic. The perimeter plate is designed to attenuate at least one of back-lobe and side-lobe radiation generated by the antenna when the perimeter plate is located around the perimeter of the antenna.

### BRIEF DESCRIPTION OF THE DRAWINGS

Other aspects, features, and advantages of the invention will become more fully apparent from the following detailed description, the appended claims, and the accompanying drawings in which like reference numerals identify similar or identical elements. Note that elements in the figures are not drawn to scale.

FIG. 1A is a perspective view of an exemplary flat panel antenna in accordance with one embodiment of the disclosure.

FIG. 1B is an enlargement of a detail area of FIG. 1A.

FIG. 2 is a side cross-sectional view of a perimeter plate similar to the perimeter plate of FIG. 1A.

FIG. 3 is an exemplary graph of the level of radiation suppression achieved over a range of different frequencies by perimeter plates with different numbers of perimeter bands.

FIG. 4A is a side cross-sectional view of a perimeter plate similar to the perimeter plate of FIG. 2, but where the features are rectilinear fins with a rounded top.

FIG. 4B is a side cross-sectional view of a perimeter plate similar to the perimeter plate of FIG. 2, but where the features are rectilinear fins with orthogonal tops.

FIG. 4C is an exemplary graph of the levels of radiation suppression achieved over a range of different frequencies by perimeter plates using features having three different geometries as well as a perimeter plate having no features.

FIG. 5 is a detailed perspective view of a perimeter plate with three perimeter bands comprising fins having semi-cylindrical tops.

FIG. 6 is a detailed perspective view of a perimeter plate with four perimeter bands comprising rectilinear pegs having square horizontal cross sections.

FIG. 7A is a detailed perspective cut-away view of an antenna system in accordance with one embodiment of the disclosure.

FIG. 7B is a detailed perspective cut-away view of an antenna system in accordance with another embodiment of the disclosure.

FIG. 7C is a detailed perspective cut-away view of an antenna system in accordance with yet another embodiment of the disclosure.

FIG. 8 is a cross-sectional view of the outer edge of an exemplary antenna in accordance with an embodiment of the disclosure.

FIG. 9 is a detailed perspective view of an antenna system in accordance with one embodiment of the disclosure.

FIG. 10 is a detailed perspective view of an antenna in accordance with an embodiment of the disclosure.

FIG. 11 is a perspective view of an antenna in accordance with an embodiment of the disclosure.

FIG. 12A is a perspective view of an antenna system in accordance with an embodiment of the disclosure.

FIG. 12B is a perspective exploded view of the antenna system of FIG. 12A.

FIG. 12C is a detailed perspective view of the antenna system of FIG. 12A.

FIG. 13A is a detailed perspective view of an antenna system that includes the dish antenna of FIG. 12B, but with a different perimeter plate.

FIG. 13B is a detailed perspective view of an antenna system that includes the dish antenna of FIG. 12B, but with a yet different perimeter plate.

### DETAILED DESCRIPTION

The proportion of radiation emitted by an antenna in the forward hemisphere may be modified by changing elements of the antenna or adding additional ones. Transmission antennas used outdoors are typically outfitted with an enclosure—such as, for example, a radome—to protect the antenna from degrading environmental factors such as, for example, windborne particles, precipitation, pollutants, and humidity. Depending on the antenna design, the enclosure may be metallic or non-metallic. The enclosure may also help attenuate unwanted radiation transmitted by the antenna. In general, the addition of certain features to an antenna or its enclosure can significantly suppress unwanted back-lobe and side-lobe radiation. These lobe-suppressing features may be, for example, an integral part of the antenna, part of an antenna enclosure, or added to the antenna as a non-enclosing add-on.

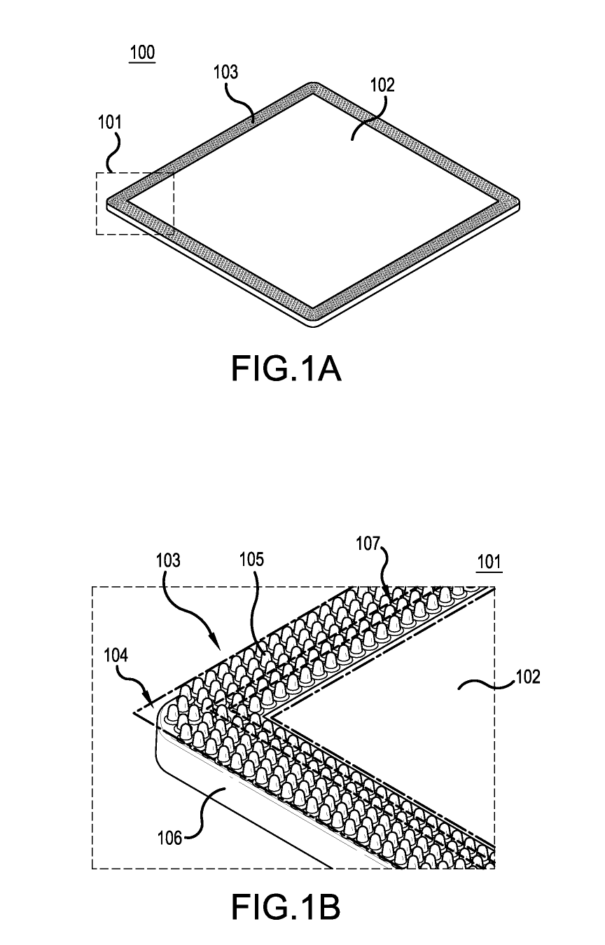

FIG. 1A is a perspective view of an exemplary flat panel antenna 100 in accordance with one embodiment of the disclosure. FIG. 1B is an enlargement of detail area 101 of FIG. 1A. Flat panel antenna 100 comprises a radome 102 and a perimeter plate 103. Antenna 100 further comprises electromagnetically radiating elements (not shown), which are covered by the radome 102 and are, therefore, not visible in FIG. 1A. The forward direction of radiation of the antenna 100 is perpendicular to the radome 102. The perimeter plate 103 is located at the perimeter of the antenna 100, and also around the radome 102. The perimeter plate 103 functions as a lobe-suppressing structure that shrinks the side-lobes and back-lobes generated by the antenna 100. Perimeter plate 103 may be an antenna-integrated feature manufactured together with the antenna 100 or may be a later add-on, which may be considered an after-market accessory, or part of the radome 102.

The perimeter plate 103 comprises an array 104 of electromagnetic-field-suppressing features 105 on top of base structure 106. The array 104 is organized as five substantially concentric, rectangular perimeter bands 107, each band 107 comprising a collection of distinct, regularly spaced EM-field-suppressing features 105. Note that some alternative embodiments of the perimeter plate 103 may have fewer or more than five perimeter bands.

The array 104 of the features 105 may be categorized as a meta-material. A meta-material is a material structured in a way—typically in a particular periodic pattern—that provides properties different from those of the bulk material of which it is composed—often properties not generally found in nature. For example, the array 104 of features 105 may suppress the surface waves of particular wavelengths while transmitting the surface waves of all other wavelengths—while, contrastingly, a solid surface of the same material would transmit surface waves of any wavelength. Suppressing surface waves of the transmission frequency of the antenna 100 would reduce the side lobes and back lobes generated by the antenna 100.

The features 105 in perimeter plate 103 are truncated cones with rounded, beveled, or chamfered tops and a metal surface. The cones 105 may be metallic or a metal-coated—also called metalized—non-metallic material such as plastic. Metals that may be used include, for example, aluminum, copper, nickel, and their alloys. In some implementations, the metal used for the perimeter plate 103 is the same as the metal used for other parts of the antenna 100. Note that, in some alternative embodiments, the features 105 may have a different shape, such as, for example, cylindrical, cubical, rectilinear, or conical.

One advantage of meta-materials over conventional choke plates that use grooves is that the ability of groove plates to transmit or reflect surface waves is dependent on the relative orientation of the impinging surface waves, while perimeter plates—such as perimeter plate 103 with features 105—are polarization-independent and achieve surface-wave suppression regardless of the relative orientation of the impinging surface wave.

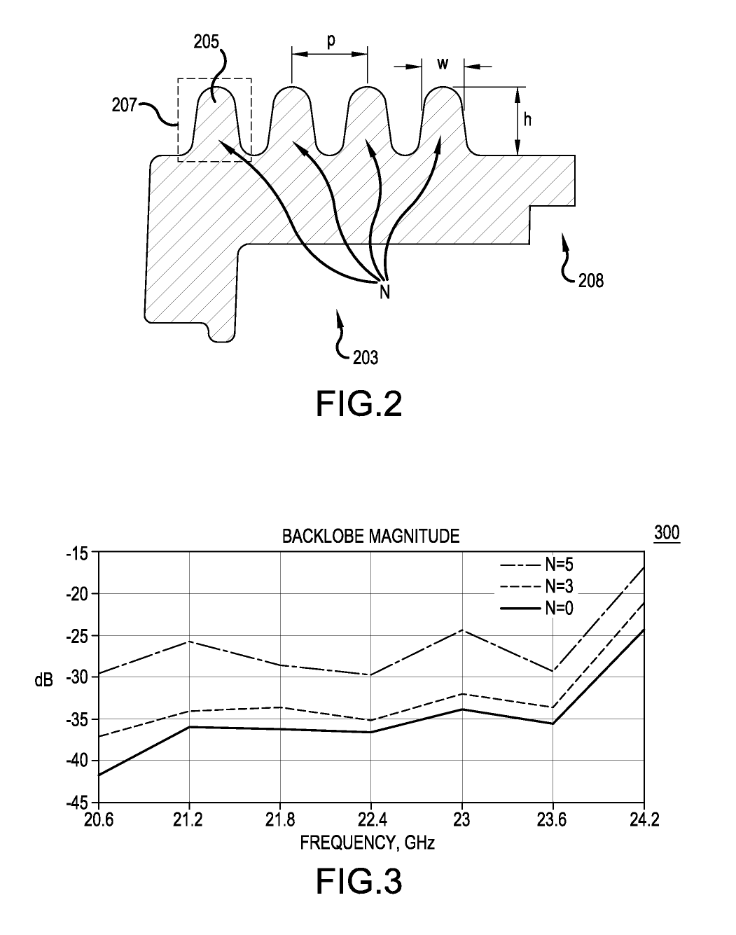

FIG. 2 is a side cross-sectional view of a perimeter plate 203 similar to the perimeter plate 103 of FIG. 1A, but where perimeter plate 203 has four perimeter bands 207 of features 205 rather than five perimeter bands 107. Note that a radome (not shown) such as the radome 102 of FIG. 1A may abut the perimeter plate 203 at the notch 208 on the right side. FIG. 2 shows various dimensions related to the perimeter plate 203, such as the number N of bands 207, the distance p between bands 207, the width w of features 205, and the height h of features 205. Note that, for features 205, which are rounded cones, whose width varies with height, the feature width w may be measured at the middle of their height h. Note that, in general, increasing the number N of perimeter bands 207 increases the resultant radiation suppression, as described below.

FIG. 3 is an exemplary graph 300 of the level of radiation suppression achieved over a range of different frequencies by perimeter plates having zero, three, and five perimeter bands. As can be seen, over the range of frequencies included, the greater the number N of perimeter bands in a perimeter plate, the greater the resultant reduction in radiation strength, as indicated by the reduced magnitude—as measured in decibels—of the back lobe. As noted above, the EM-field-suppressing features may have geometries other than rounded cones. For example, fins or rectilinear pins may be used. The term “fin,” as used herein, as described below, and as illustrated in the figures, refers to a substantially rectilinear box whose height and length are greater than its width, where (i) its height is measured from the surface of the corresponding perimeter plate, (ii) its length is measured parallel to the perimeter band in which it is located, (iii) its width substantially corresponds to the width of the perimeter band in which it is located, and (iv) it is separated from adjoining fins in the perimeter band in which it is located by spaces. A perimeter band may be formed from a set of distinct, regularly spaced fins. A fin may have, for example, a rounded, semi-cylindrical, beveled, or chamfered top.

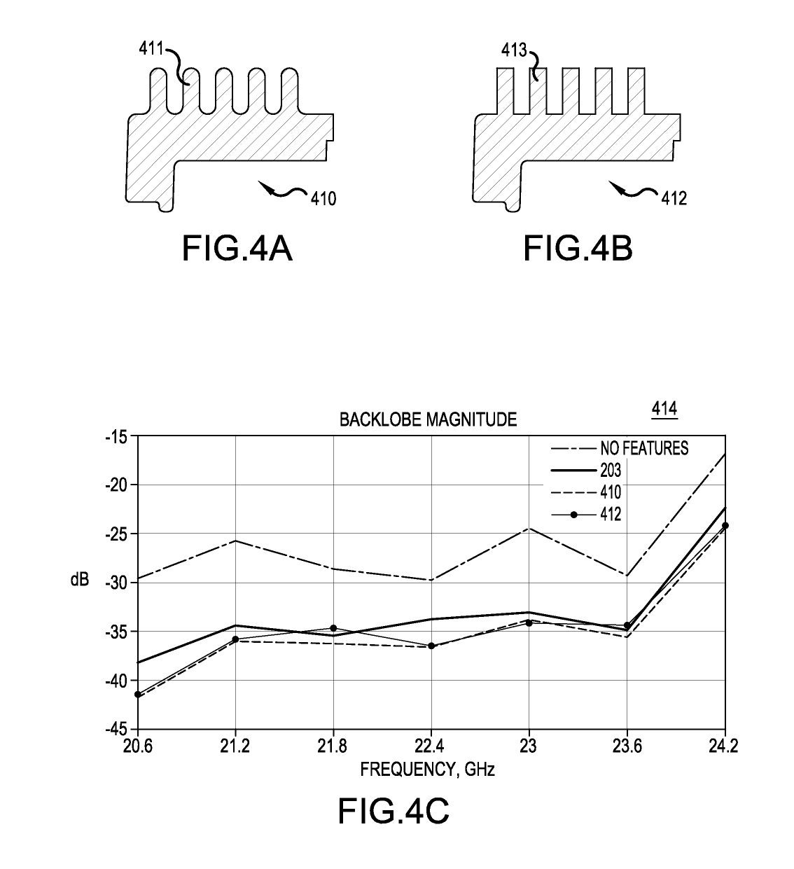

FIG. 4A is a side cross-sectional view of a perimeter plate 410 similar to the perimeter plate 203 of FIG. 2, but where the features 411 are rectilinear fins having rounded tops. FIG. 4B is a side cross-sectional view of a perimeter plate 412 similar to the perimeter plate 203 of FIG. 2, but where the features 413 are rectilinear fins having flat tops. FIG. 4C is an exemplary graph 414 of the levels of radiation suppression achieved over a range of different frequencies by perimeter plates using features having the three different geometries of plates 203, 410, and 412 of FIGS. 2, 4A, and 4B, as well as a perimeter plate having no features. As can be seen in graph 414, using a perimeter plate with any of the three geometries of features 205 (cones with rounded tops), 411 (fins with rounded tops), or 413 (fins with flat tops) provides greater attenuation than using a perimeter plate with no EM-field-suppressing features, as indicated by the reduced back-lobe magnitude for antennas using perimeter plates with any of the three above-described features.

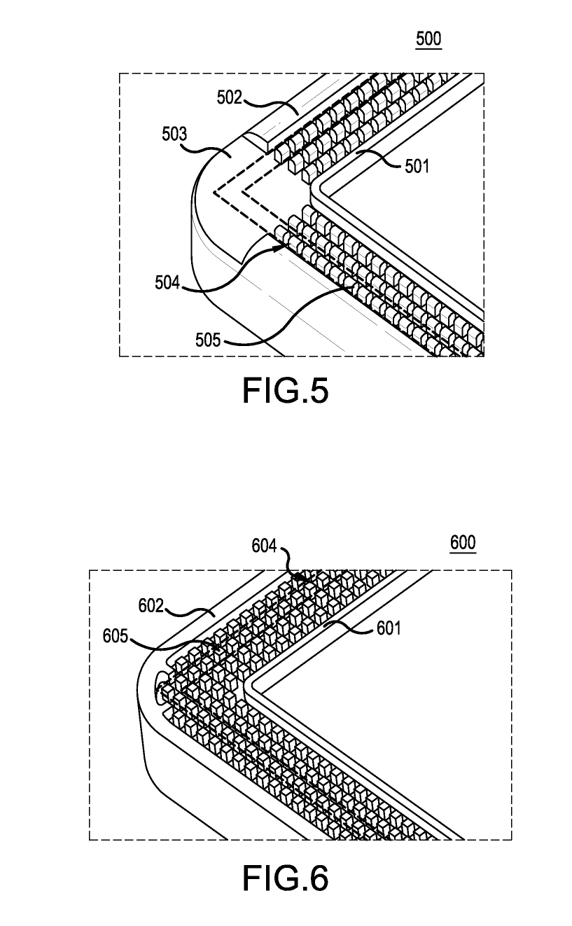

FIG. 5 is a detailed perspective view of a perimeter plate 500 with three perimeter bands 504 comprising fins 505 having semi-cylindrical tops. Note that the perimeter plate 500 also comprises an inner guard band 501 and an outer guard band 502. The guard bands 501 and 502 are optional features that (1) may provide structural support to the antenna (not shown) and/or perimeter-plate enclosure (not shown) and/or (2) improve the aesthetic appearance of the antenna and/or perimeter-plate enclosure. Examples of perimeter-plate enclosures are described further below. Note also that the perimeter plate 500 has a corner gap 503 where there are discontinuities in the outer guard band 502 and the perimeter bands 504. The corner gap 503 may be useful, for example, for water drainage. In an alternative implementation, the inner guard band 501 may also have a corresponding discontinuity in the corner gap 503.

FIG. 6 is a detailed perspective view of a perimeter plate 600 with four perimeter bands 604 comprising rectilinear pegs 605, which are EM-suppressing features and which have square horizontal cross sections. Note that the perimeter plate 600 also comprises inner guard band 601 and outer guard band 602, where the guard bands 601 and 602 do not have band discontinuities.

Note that, for any particular implementation of the described embodiments, the particular dimensions of the EM-suppressing features used may depend on a plurality of factors and may be chosen so as to provide at least satisfactory EM-field suppression for the range of frequencies used by the corresponding antenna within perimeter-plate constraints—such as, for example, size, weight, durability, material cost, and manufacturing cost.

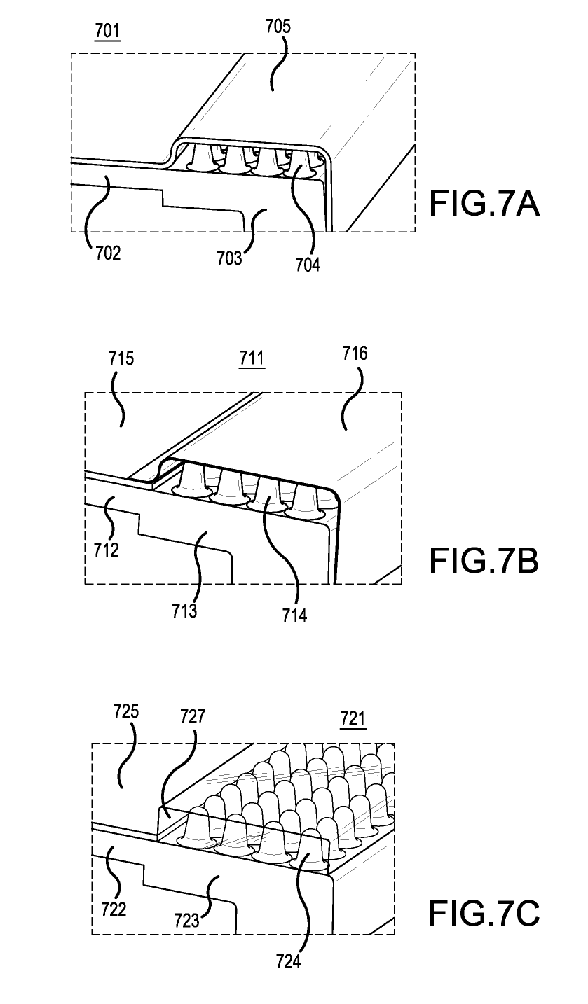

FIG. 7A is a detailed perspective cut-away view of an antenna system 701 in accordance with one embodiment of the disclosure. FIG. 7B is a detailed perspective cut-away view of an antenna system 711 in accordance with another embodiment of the disclosure. FIG. 7C is a detailed perspective cut-away view of an antenna system 721 in accordance with yet another embodiment of the disclosure. The three antenna systems 701, 711, and 721 have different corresponding elements for providing protection to their respective perimeter plates against environmental degradation from, for example, weather and pollutants.

Antenna system 701 of FIG. 7A comprises antenna 702, which includes radiating antenna elements (not shown) and perimeter plate 703, which includes an array of EM-field-suppressing features 704. Antenna system 711 of FIG. 7B comprises antenna 712 and perimeter plate 713, which includes EM-field-suppressing features 714. Antenna system 721 of FIG. 7C comprises antenna 722 and perimeter plate 723, which includes EM-field-suppressing features 724.

In antenna system 701 of FIG. 7A, protection is provided to both the antenna 702 and the features 704 by a single radome 705 that covers both the antenna 702 and the features 704. The radome 705 may be affixed to the antenna system 701 by, for example, snapping on, fixing with a fastener, or attachment with an adhesive.

In antenna system 711 of FIG. 7B, the antenna 712 is covered by a radome 715 while the features 714 are covered by a tape 716 that is different from the radome 715. The tape 716 may be a flexible film or a more-rigid material and may be secured to the antenna system 711 with, for example, an adhesive. The tape 716 itself may be already provided with an adhesive or a separate adhesive (not shown) may be applied just prior to the attachment of the tape 716 to the antenna system 711.

In antenna system 711 of FIG. 7C, the antenna 722 is covered by a radome 725, while the features 724 are protected by a dielectric material 727, which fills the spaces between and around the features 724. The dielectric material 727 may be of any suitable material and may extend any suitable height above the tops of the suppressing features.

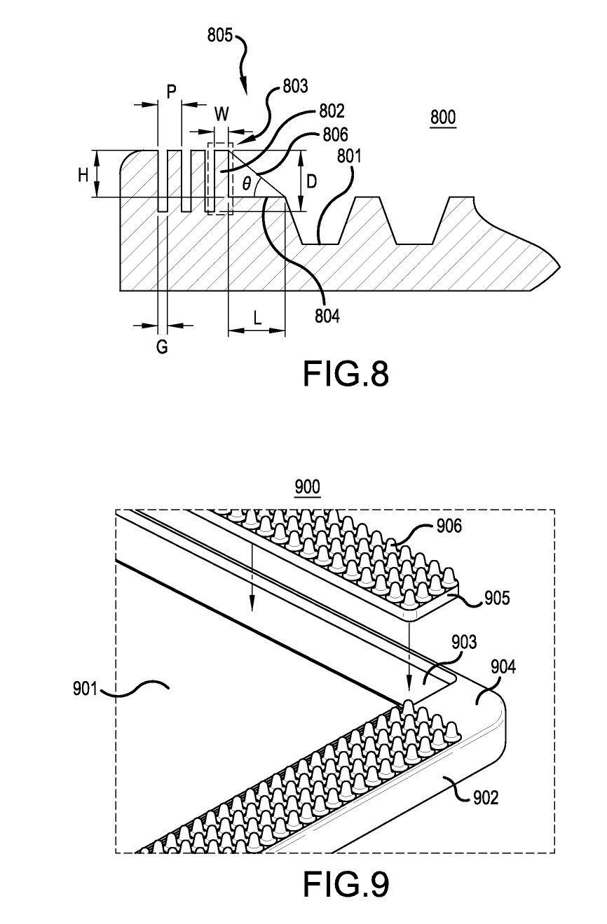

FIG. 8 is a cross-sectional view of the outer edge of an exemplary antenna 800 in accordance with an embodiment of the disclosure. FIG. 8 shows various dimensions related to the antenna 800. Namely, the distance L is the distance between the outermost radiating element 801 of the antenna 800 and the features 802 of the innermost perimeter band 803 of EM-field-suppressing features 802. The distance L should be in the range of 0.2λ≦L≦0.4λ, where λ is the wavelength of the electromagnetic radiation generated by the radiating elements 801 of the antenna 800. The angle θ is the angle between the surface 804 of the perimeter plate 805 of the antenna 800 and the line 806 from the edge of the outermost radiating element 801 to the top of the features 802 of the innermost perimeter band 803. The angle θ should be in the range of 0°≦θ≦65°.

The height H is the height of the EM-suppressing features 802 relative to the top of the apertures of the radiating elements 801 and should be in the range of 0≦H≦0.4λ. The distance P is the periodic distance of the bands 803 and should be less than or equal to λ/3. The width W is the width of the features 802 of the perimeter bands 803 and should be approximately P/2. The distance G is the gap width—in other words, the distance between the features 802 of adjacent perimeter bands 803—and should also be approximately P/2. The depth D is the depth of the suppressing features 802 and should be approximately λ/4. Note that, in some alternative embodiments, there may be an air or dielectric gap (not shown) between the outermost radiating elements 801 and the features 802 of the innermost perimeter band 803.

FIG. 9 is a detailed perspective view of an antenna system 900 in accordance with one embodiment of the disclosure. Antenna system 900 comprises radome 901 and perimeter base structure 902. The perimeter base structure 902 includes recesses 903 and corner gaps 904. The corner gaps 904, similar to the corner gaps 503 of FIG. 5, may be used for the drainage of water from the antenna system 900. Separately manufactured perimeter strips 905, which include arrays of EM-field-suppressing features 906, are inserted into the recesses 903. This allows for the relatively inexpensive mass manufacture of customizable perimeter base structures 902, each of which may subsequently be fitted with customized perimeter strips 905 that may be customized for particular transmission frequencies or other operating parameters. Perimeter strips 905 may also be replaceable, thereby allowing modification of the suppression capabilities of the antenna system 900 without replacement of the entire antenna system 900. Note that, in antenna system 900, the combination of the perimeter strips 905 and the perimeter base structure 902 forms the perimeter plate of the antenna system 900.

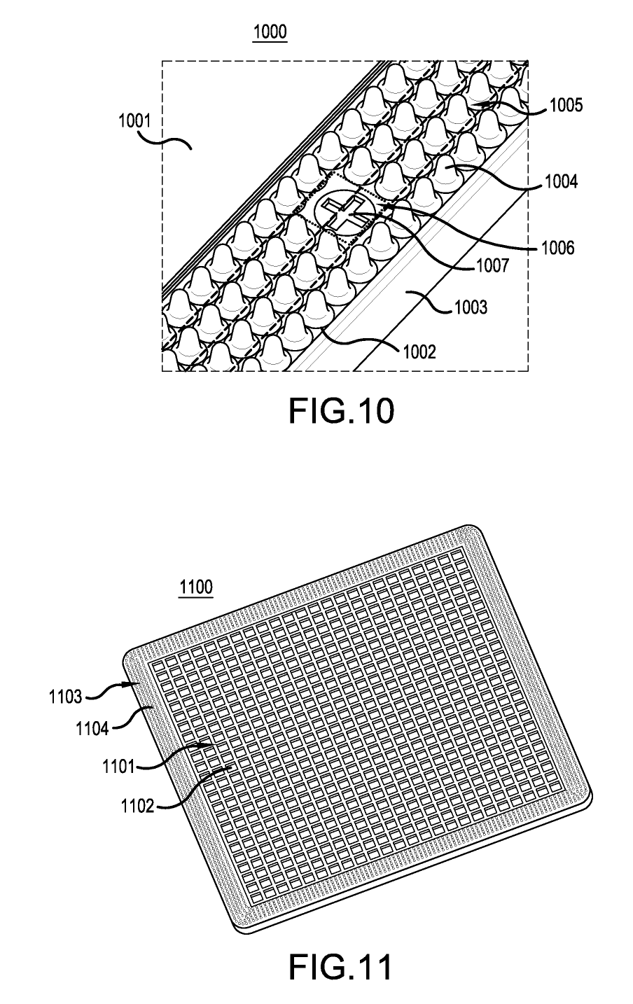

FIG. 10 is a detailed perspective view of an antenna system 1000 in accordance with an embodiment of the disclosure. The antenna 1000 comprises a radome 1001 and a perimeter base structure 1003. The antenna 1000, similarly to antenna 900 of FIG. 9, uses customized perimeter strips 1002 inserted in the perimeter base structure 1003. Each perimeter strip 1002 comprises an array of EM-field-suppressing features 1004 organized into concentric perimeter bands 1005. Each perimeter strip 1002 is placed inside a corresponding recess (not shown) of the perimeter base structure 1003. A couple of the perimeter bands 1005 have a gap 1006 to allow for the placement of a fastener 1007 for securing the perimeter strip 1002 to the perimeter base structure 1003. Note that, in an alternative embodiment, the perimeter strip 1002 may be a single continuous element of the antenna system 1000, or, alternatively, may be divided into fewer or more than four individual perimeter strips. Note further that the perimeter strip 1002 may also have other gaps and/or local modifications for other purposes.

FIG. 11 is a perspective view of an antenna 1100 in accordance with an embodiment of the disclosure. Antenna 1100 comprises an array 1101 of radiating elements 1102, where the array 1101 is surrounded by a perimeter plate 1103. The perimeter plate 1103 comprises an array of EM-field-suppressing features 1104. The array 1101 and perimeter plate 1103 are manufactured together and form integral parts of the antenna 1100.

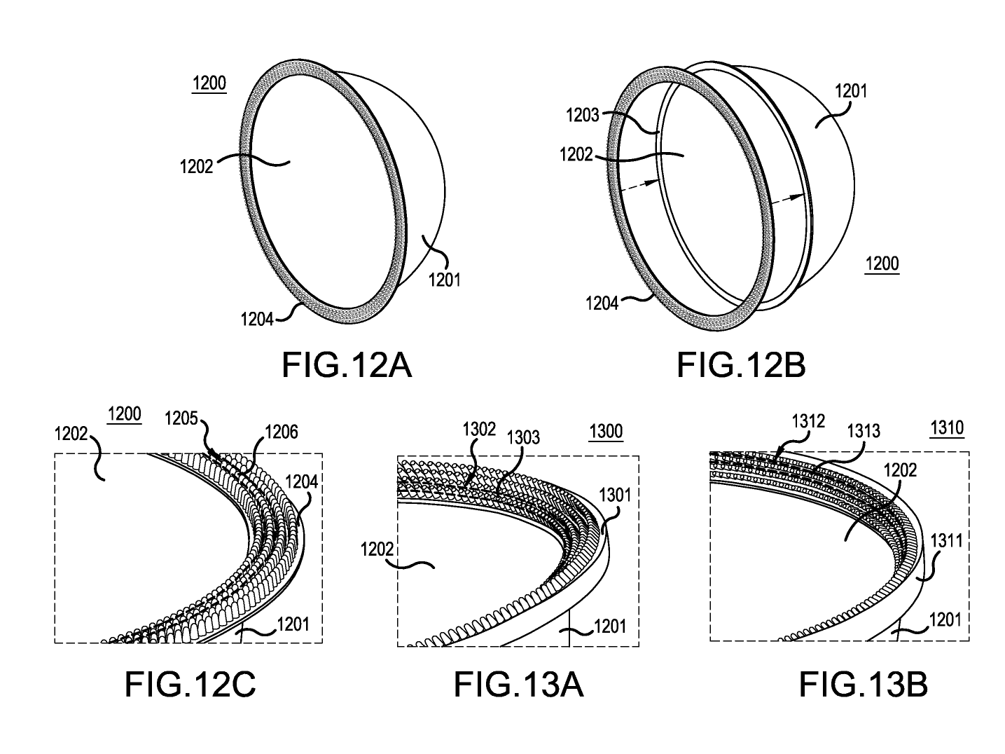

FIG. 12A is a perspective view of an antenna system 1200 in accordance with an embodiment of the disclosure. FIG. 12B is a perspective exploded view of the antenna system 1200 of FIG. 12A. FIG. 12C is a detailed perspective view of the antenna system 1200 of FIG. 12A. The antenna system 1200 comprises a parabolic dish antenna 1201 having an aperture 1202 with an aperture rim 1203. The antenna system 1200 further comprises a perimeter plate 1204 attached to the aperture rim 1203. The perimeter plate 1204 comprises four concentric, annular perimeter bands 1205 comprising EM-suppressing features 1206 shapes as rounded cones. The antenna system 1200 may further include a radome (not shown) that covers and protects the aperture 1202 and/or the perimeter plate 1204. Note that the antenna system 1200 demonstrates that the use of perimeter plates of meta-materials is not limited to a specific type of antenna.

FIG. 13A is a detailed perspective view of an antenna system 1300, which includes the dish antenna 1201 of FIG. 12B, but with a different perimeter plate 1301. FIG. 13B is a detailed perspective view of an antenna system 1310, which includes the dish antenna 1201 of FIG. 12B, but with a yet different perimeter plate 1311. Similar to perimeter plate 1204 of FIG. 12C, (i) perimeter plate 1301 comprises four concentric perimeter bands 1302 comprising EM-suppressing cones 1303 and (ii) perimeter plate 1311 comprises four concentric perimeter rings 1312 comprising EM-suppressing cones 1313. While the cones 1206 of the perimeter plate 1204 are substantially perpendicular to the plane of the perimeter plate 1204, the cones 1303 and 1313 of, respectively, perimeter plates 1301 and 1311 are tilted at different angles to the plane of the respective perimeter plates 1301 and 1311. Specifically, the cones 1303 of the perimeter plate 1301 are tilted about 30 degrees from the perpendicular while the cones 1313 of the perimeter plate 1311 are tilted about 60 degrees from the perpendicular. Note that the perimeter plates 1301 and 1311 are shaped to accommodate the above-described tilts of the corresponding cones, where their respective bases are similarly tilted.

A perimeter plate may be manufactured (i) together with the corresponding antenna, (ii) together with the antenna housing, (iii) as an add-on for attachment to the antenna, or (iv) as an add-on for attachment to antenna housing. The perimeter plate may be one continuous structure or may be a multi-part, discontinuous structure. A perimeter plate may be designed to suppress back-lobe and/or side-lobe radiation.

A metal perimeter plate may be manufactured using any suitable means for manufacturing shaped metal objects, such as, for example, casting, die-casting, extrusion, injection molding, machining, milling, and etching. A metalized plastic perimeter plate may be manufactured by any suitable means for manufacturing shaped plastic objects for example, injection molding and coated with metal using, for example, vapor metallization, arc spraying, flame spraying, electroplating, and electroless plating.

Some alternative embodiments of the perimeter plate comprise only one band of EM-suppressing features.

In some alternative embodiments, the EM-suppressing features of the bands are irregularly spaced and/or the EM-suppressing features' geometry is locally modified in order to increase the frequency range of operation or to suppress radiation in separate frequency bands. In other words, varying the number of perimeter bands, the gap width between perimeter bands, the spacing between suppressing features within a perimeter band, and/or the geometry of the suppressing features—e.g., width w, height h, and/or shape—may allow the perimeter plate to suppress a wider band of frequencies or multiple frequency bands.

Embodiments of the disclosure have been disclosed where the EM-field-suppressing features of the perimeter plate are organized in perimeter bands. In alternative embodiments, however, the suppressing features of the perimeter plate may be organized in patterns other than bands. For example, the suppressing features may be organized in diamond, beehive, or irregular patterns.

It will be further understood that various changes in the details, materials, and arrangements of the parts which have been described and illustrated in order to explain the nature of this invention may be made by those skilled in the art without departing from the scope of the invention as expressed in the following claims.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless explicitly stated otherwise, each numerical value and range should be interpreted as being approximate as if the word “about” or “approximately” preceded the value of the value or range. As used in this application, unless otherwise explicitly indicated, the term “connected” is intended to cover both direct and indirect connections between elements.

The use of figure numbers and/or figure reference labels in the claims is intended to identify one or more possible embodiments of the claimed subject matter in order to facilitate the interpretation of the claims. Such use is not to be construed as limiting the scope of those claims to the embodiments shown in the corresponding figures.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

Although the steps in the following method claims are recited in a particular sequence with corresponding labeling, unless the claim recitations otherwise imply a particular sequence for implementing some or all of those steps, those steps are not necessarily intended to be limited to being implemented in that particular sequence.

We claim:

1. An article of manufacture comprising a perimeter plate adapted to be located around the perimeter of an antenna, wherein:
the perimeter plate comprises one or more concentric perimeter bands;
each perimeter band comprises a plurality of distinct EM-field-suppressing features;
the surface of each suppressing feature is metallic; and
the perimeter plate is designed to attenuate at least one of back-lobe and side-lobe radiation generated by the antenna when the perimeter plate is located around the perimeter of the antenna.

2. The article of claim 1, wherein:
the antenna comprises an array of electromagnetically radiating elements; and
a distance L between the innermost perimeter band and the outermost radiating elements is in the range of 0.2λ≦L≦0.4λ, where λ is the wavelength of the electromagnetic radiation generated by the radiating elements.

3. The article of claim 2, wherein:
the perimeter plate defines a plane;
an angle θ between (i) the perimeter-plate plane and (ii) a line from the edge of the outermost radiating elements to the top of the features of the innermost perimeter band is in the range of 0°≦θ≦65°.

4. The article of claim 3, wherein a height H of the features relative to a top of the apertures of the radiating elements is in the range of 0≦H≦0.4λ.

5. The article of claim 4, wherein:
the perimeter plate comprises at least two perimeter bands;
a periodic distance P of adjacent perimeter bands is less than or equal to λ/3.

6. The article of claim 5, wherein:
a width W of the features of the perimeter bands is P/2;
a gap distance G between the features of adjacent perimeter bands is P/2; and
a depth D of the features is λ/4.

7. The article of claim 1, wherein:
the perimeter plate comprises one or more concentric perimeter bands; and
the features of the perimeter bands form a meta-material array.

8. The article of claim 1, wherein the features are truncated cones.

9. The article of claim 1, wherein the features are rectilinear fins.

10. The article of claim 1, wherein the perimeter plate further comprises:
an outer guard band located around the one or more concentric perimeter bands; and
an inner guard band located inside the innermost perimeter bands.

11. The article of claim 1, wherein the perimeter plate has one or more corner gaps in the one or more concentric perimeter bands.

12. The article of claim 1, further comprising:
a radome adapted to cover and protect the antenna; and
structure adapted to cover and protect the features.

13. The article of claim 12, wherein the structure is an integral part of the radome.

14. The article of claim 12, wherein the structure is a tape adhered to the radome and to the perimeter plate.

15. The article of claim 12, wherein the structure is a dielectric material that fills the spaces between and around the features.

16. The article of claim 1, wherein the perimeter plate comprises:
a perimeter base structure with one or more recesses; and
one or more corresponding perimeter strips comprising the features, wherein the perimeter strips are inserted in the corresponding recesses.

17. The article of claim 1, wherein:
the antenna is a parabolic dish antenna having a circular aperture; and
the perimeter plate is a circular ring attached to the aperture.

18. The article of claim 17, wherein:
the perimeter plate defines a plane; and
the features are perpendicular to the plane of the perimeter plate.

19. The article of claim 17, wherein:
the perimeter plate defines a plane; and
the features are tilted away from the perpendicular to the plane of the perimeter plate.
